(19) United States
(12) Patent Application Publication
(10) Pub. No.: US 2024/0212897 A1
(43) Pub. Date: Jun. 27, 2024

(54) PERMANENT MAGNET MATERIAL HAVING MULTILAYER STRUCTURE, PREPARATION METHOD THEREFOR AND USE THEREOF

(71) Applicant: YANTAI ZHENGHAI MAGNETIC MATERIAL CO., LTD., Yantai (CN)

(72) Inventors: Zhiqiang LI, Yantai (CN); Lei LIU, Yantai (CN); Meng XUE, Yantai (CN); Yunying JIANG, Yantai (CN); Meng LI, Yantai (CN)

(21) Appl. No.: 18/395,407

(22) Filed: Dec. 22, 2023

(30) Foreign Application Priority Data
Dec. 23, 2022 (CN) 2022116667946

(51) Int. Cl. H01F 1/057; H01F 7/02

(52) U.S. Cl. CPC H01F 1/0577; H01F 7/02

(57) ABSTRACT

A permanent magnet material having the multilayer structure can obtain a high-performance permanent magnet material under the condition of a reduced content of Nd. By means of powder preparation, mixing, pressing, and sintering, the performance defect such as the reduction of the magnet property caused by CeY entering the main phase grains is effectively avoided, and the influence of the formation of a CeFe₂ phase in the grain boundaries on the magnet property is also avoided. Moreover, by the introduction of M, the inhibition of CeY enrichment in the grain boundaries on the diffusion effect is avoided, a diffusion channel of heavy rare earth from the surface of the magnet to the interior is provided, and thus the diffusion effect is optimized, and the diffusion performance is significantly improved.

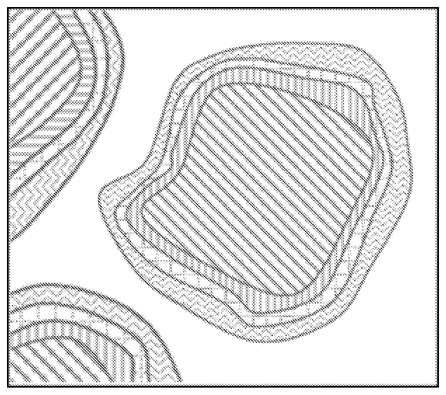

### CROSS-REFERENCE TO RELATED APPLICATION

The present application claims priority to the prior patent application with the Chinese application No. 202211666794.6 and entitled “PERMANENT MAGNET MATERIAL HAVING MULTILAYER STRUCTURE, PREPARATION METHOD THEREFOR AND USE THEREOF”, filed with the China National Intellectual Property Administration on Dec. 23, 2022, the content of which is incorporated herein by reference in its entirety.

### TECHNICAL FIELD

The present disclosure relates to the field of magnet materials, and particularly, to a permanent magnet material having a multilayer structure, a preparation method therefor and use thereof.

### BACKGROUND

The permanent magnet material is also called hard magnetic material, and is characterized by high anisotropy field, high coercivity, large hysteresis loop area, large magnetization field required for magnetization to saturation, and capability of keeping strong magnetism for a long time after an external magnetic field is removed. Among permanent magnet materials, sintered neodymium-iron-boron (NdFeB) based permanent magnets have more outstanding magnetic property advantages than other permanent magnet materials. For example, the sintered NdFeB based permanent magnets have higher magnetic energy product, coercivity and energy density, have good mechanical property, and are casy to process. These excellent properties make the sintered NdFeB permanent magnets widely used in modern industry and electronics, more commonly in motors, loudspeakers, magnetic separators, computer disk drives, magnetic resonance imaging devices, and the like. However, with the rapid development of low-carbon, environment-friendly, economical, and high-new technologies, the demand for sintered NdFEB magnets is increasing day by day, which greatly drives the consumption of rare earth PrNd resources, such that the price of PrNd is gradually increased. Although the document adopts La and Ce instead of Pr and Nd to be applied to the sintered NdFEB so as to reduce the cost of starting materials, the addition of Ce in the existing permanent magnet material product and process often brings about the reduction of Nd content, and the product performance of the permanent magnet material is affected. Therefore, an urgent need for a magnet material comprising Ce and having excellent properties is present all the time.

### SUMMARY

In order to solve the problems described above, the present disclosure provides a permanent magnet material, wherein the microstructure of the permanent magnet material comprises a main phase and an at least three-layer shell structure, wherein the three-layer shell structure comprises a first-layer shell structure, a second-layer shell structure, and a third-layer shell structure disposed from near to far according to distances between the structures and the main phase, wherein,
the main phase comprises R-T-B main phase grains, wherein the R is selected from one, two, or more of neodymium (Nd), prascodymium (Pr), gadolinium (Gd), holmium (Ho), dysprosium (Dy), and terbium (Tb); the T comprises iron (Fe), and optionally other metal elements present or absent; the B is boron;
the first-layer shell structure is a Ce-rich and/or Y-rich layer, preferably the CeY-rich layer;
the second-layer shell structure is a layer comprising M, wherein the M is selected from one, two, or more of transition metal elements, low-melting-point metals, and non-metal elements;
the third-layer shell structure is a layer rich in a heavy rare earth element, wherein the heavy rare earth element is selected from one, two, or more of terbium (Tb), dysprosium (Dy), and holmium (Ho).

According to an embodiment of the present disclosure, the R is preferably selected from Nd and NdPr.

According to an embodiment of the present disclosure, the Tis preferably selected from iron (Fe) or a mixture of iron and other metal elements, wherein the other metals may be selected from one, two, or more of transition metal elements and low-melting-point metal elements.

The transition metal elements in the context of the present disclosure have the meaning well known in the art and refer to the metal elements of regions d and ds in the periodic table of elements, wherein the elements of region d include elements of groups IIIB to VIIB, VIII, but exclude lanthanides and actinides; the elements of region ds include elements of groups IB to IIB. Generally, the transition metal elements include elements of a total of ten groups of 3 to 12, but exclude internal transition elements of region f, wherein elements No. 58 to 71 in the periodic table are called internal transition elements of 4f, and elements No. 90 to 103 are called internal transition elements of 5f, all of which are elements of region f.

According to an embodiment of the present disclosure, the transition metal element may be selected from one, two, or more of copper (Cu), zirconium (Zr), titanium (Ti), tin (Sn), and manganese (Mn); the low-melting-point metal element may be selected from one or two of Al, Ga, and the like.

According to an embodiment of the present disclosure, the non-metal may be boron.

According to an embodiment of the present disclosure, the M may be selected from one or more of Cu, Ga, Al, Zr, Ti, Sn, Mn, B, V, and Se, such as one or more of Cu, Ga, Al, Zr, Ti, Sn, Mn, and Se, preferably one, two, or more of Cu, Ga, Al, Sn, and Mn.

According to an embodiment of the present disclosure, the mass percentage of the R in the main phase grains may be 27% to 33%; and/or, the mass percentage of the T may be 63% to 70%; and/or, the mass percentage of the B may be 0.85% to 1.1%.

Furthermore, the ratio of (Pr+Nd)/RE in the main phase grains is not less than 90%, based on the mass percentage.

According to an embodiment of the present disclosure, the ratio of (Ce+Y)/RE in the first-layer shell structure is not less than 20%, based on the mass percentage.

According to an embodiment of the present disclosure, the mass percentage of the M in the second-layer shell structure is not less than 5%, based on the mass percentage.

According to an embodiment of the present disclosure, the ratio of HRE/RE in the third-layer shell structure is not less than 20%, based on the mass percentage.

According to an embodiment of the present disclosure, the thickness of each shell structure is the same as or different from each other, and may be independently selected from 1-6 nm, such as 1 nm, 2 nm, 3 nm, 4 nm, 5 nm, or 6 nm.

As an example, the thickness of the first-layer shell structure may be selected from 2-6 nm, such as 2 nm, 3 nm, 4 nm, 5 nm, or 6 nm, preferably 3-5 nm.

As an example, the thickness of the second-layer shell structure may be selected from 1-4 nm, such as 1 nm, 2 nm, 3 nm, or 4 nm, preferably 2-3 nm.

As an example, the thickness of the third-layer shell structure may be selected from 5-7 nm, such as 5 nm, 6 nm, or 7 nm, preferably 6 nm.

According to an embodiment of the present disclosure, an overlapping region of the second-layer shell structure and the third-layer shell structure may be present. The overlapping region refers to a region having both the characteristics of the second-layer shell structure and the third-layer shell structure, for example, a region satisfying both “the mass percentage of the M not less than 5%” and “the ratio of HRE/RE not less than 20%”.

According to an embodiment of the present disclosure, the mass percentage of the R is not less than 28.5% and not more than 32.5%, for example, 29.0%, 29.5%, 30.0%, 30.5%, 31.0%, 31.5%, 32.0%, or 32.5%, based on the mass of the permanent magnet material.

According to an embodiment of the present disclosure, the mass percentage of the B is not less than 0.88% and not more than 1.05%, for example, 0.90%, 0.95%, 1.00%, or 1.05%, based on the mass of the permanent magnet material.

According to an embodiment of the present disclosure, the total mass percentage of the M is not less than 0.1% and not more than 4.0%, for example, 0.1%, 0.5%, 1.0%, 1.5%, 2.0%, 2.5%, 3.0%, 3.5%, or 4.0%, preferably not less than 0.3% and not more than 3.0%, based on the mass of the permanent magnet material.

According to an embodiment of the present disclosure, the permanent magnet material may comprise Co. Preferably, the mass percentage of the Co is not less than 0% and not more than 3.0%, for example, 0.1%, 0.5%, 1.0%, 1.5%, 2.0%, 2.5%, or 3.0%, based on the mass of the permanent magnet material. According to an embodiment of the present disclosure, the balance of the permanent magnet material is Fe, O, and an inevitable impurity, wherein the inevitable impurity is, for example, at least one selected from C, N, and the like.

According to an embodiment of the present disclosure, the mass percentage of the O is 300-4000 ppm, for example, 700-4000 ppm, such as 700 ppm, 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3100 ppm, 3200 ppm, 3300 ppm, 3400 ppm, 3500 ppm, 3600 ppm, 3700 ppm, 3800 ppm, 3900 ppm, or 4000 ppm, based on the mass of the permanent magnet material.

According to an embodiment of the present disclosure, the permanent magnet material may comprise C. For example, the mass percentage of the C is 400-800 ppm, based on the mass of the permanent magnet material.

According to an embodiment of the present disclosure, the crystal grain size of the permanent magnet material is not more than 6 μm, for example, 0.1 μm to 6 μm, such as 0.1 μm, 0.5 μm, 1.0 μm, 1.5 μm, 2.0 μm, 2.5 μm, 3.0 μm, 3.5 μm, 4.0 μm, 4.5 μm, 5.0 μm, 5.5 μm, or 6.0 μm.

The present disclosure further provides a composition, which comprises an R-T-B alloy, a CeY alloy, and an M compound.

According to an embodiment of the present disclosure, the M compound is preferably selected from one, two, or more of oxides, nitrides, and fluorides of the transition metal elements Ga and Al, and oxides and nitrides of non-metals as described above.

According to an embodiment of the present disclosure, the composition is present in the form of a powder. The particle size of the powder may be not more than 500 μm, for example, 0.5 μm to 300 μm, preferably 1 μm to 200 μm, more preferably 10 μm to 100 μm, and an example thereof may be 0.5 μm, 1 μm, 1.5 μm, 2 μm, 2.5 μm, 3 μm, 3.5 μm, 4 μm, 4.5 μm, 5 μm, 6 μm, 7 μm, 8 μm, 9 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 350 μm, 400 μm, 450 μm, or 500 μm.

According to an embodiment of the present disclosure, the mass ratio of the R-T-B alloy to the CeY alloy in the composition is 1:(0.01-0.1), for example, 1:0.01, 1:0.02, 1:0.03, 1:0.04, 1:0.05, 1:0.06, 1:0.07, 1:0.08, 1:0.09, or 1:0.1.

According to an embodiment of the present disclosure, the mass percentage of the M compound is 0.05 wt % to 5 wt %, for example, 0.05 wt %, 0.1 wt %, 0.15 wt %, 0.2 wt %, 0.25 wt %, 0.3 wt %, 0.35 wt %, 0.4 wt %, 0.45 wt %, or 0.5 wt %, based on the sum of the masses of the R-T-B alloy and the CeY alloy.

According to an embodiment of the present disclosure, the mass percentage of the Y is 10 wt % to 30 wt %, for example, 10 wt %, 15 wt %, 20 wt %, 25 wt %, or 30 wt %, based on the mass of the CeY alloy. The present disclosure further provides a sintered material comprising the composition sintered.

The present disclosure further provides a method for preparing the permanent magnet material, which comprises sintering the composition.

According to an embodiment of the present disclosure, the sintering comprises two heat treatments, preferably two aging treatments. Preferably, the two aging treatments comprise a primary aging treatment at the temperature of 700-950° C. and a secondary aging treatment at the temperature of 450-560° ° C.

According to an embodiment of the present disclosure, the composition is further subjected to a powdering process before the sintering treatment. The powdering process may be selected from a powder metallurgy process and a hydrogen decrepitation and jet milling process.

According to an embodiment of the present disclosure, the method for preparing the permanent magnet material comprises the following steps:
(1) performing hydrogen decrepitation treatment on a mixture of the R-T-B alloy and the CeY alloy to obtain a hydrogen-decrepitated product;
(2) performing dehydrogenation treatment on the hydrogen-decrepitated product in the step (1) to obtain a dehydrogenated product;
(3) crushing the dehydrogenated product obtained in the step (2) by jet milling or a combined mode of medium grinding and jet milling to obtain a jet-milled powder;
(4) mixing the jet-milled powder obtained in the step (3) with the M compound to obtain a mixture; (5) performing heat treatment on the mixture obtained in the step (4) to obtain a heat-treated product; and
(6) molding the heat-treated product in the step (5).

According to an embodiment of the present disclosure, in the step (1), the mass ratio of the R-T-B alloy to the CeY alloy is 1:(0.01-0.1), for example, 1:0.01, 1:0.02, 1:0.03, 1:0.04, 1:0.05, 1:0.06, 1:0.07, 1:0.08, 1:0.09, or 1:0.1.

According to an embodiment of the present disclosure, in the step (1), the hydrogen absorption pressure of the hydrogen decrepitation treatment is 150 kPa to 250 kPa.

According to an embodiment of the present disclosure, in the step (2), the temperature of the dehydrogenation treatment is 300-450° C., and/or, the time for the dehydrogenation treatment is 1˜4 hours.

According to an embodiment of the present disclosure, in the step (3), the target particle size SMD of the jet-milled powder is 1.5-3.5 μm.

According to an embodiment of the present disclosure, in the step (4), the proportion of the M compound added is 0.05-0.5 wt %, for example, 0.05 wt %, 0.1 wt %, 0.15 wt %, 0.2 wt %, 0.25 wt %, 0.3 wt %, 0.35 wt %, 0.4 wt %, 0.45 wt %, or 0.5 wt %, based on the mass of the jet-milled powder.

According to an embodiment of the present disclosure, in the step (5), the temperature of the heat treatment is 300-550° C.; and/or, the time for the heat treatment is 3-5 hours.

According to an embodiment of the present disclosure, in the step (6), a lubricant is further added before the molding treatment. Preferably, the proportion of the lubricant added is 0.1-0.5 wt %, based on the mass of the heat-treated product.

According to an embodiment of the present disclosure, the method for preparing the permanent magnet material may comprise the following exemplary steps:
mixing the R-T-B alloy with the CeY alloy according to the mass ratio of 1:(0.01-0.1), and performing hydrogen decrepitation (HD) treatment, wherein the HD hydrogen absorption pressure is 150 kPa to 250 kPa;
performing dehydrogenation treatment after saturated hydrogen absorption and decrepitation, wherein the dehydrogenation temperature is 300-450° C., and the dehydrogenation time is 1˜4 hours;
after dehydrogenation treatment, crushing the dehydrogenated product by jet milling or a combined mode of medium grinding and jet milling to obtain a jet-milled powder with the target particle size SMD of 1.5-3.5 μm;
adding the prepared jet-milled powder with an M compound at a proportion of 0.05-0.5 wt %; and
performing heat preservation treatment on the jet-milled powder added with the M compound at 300-550° ° C. for 3-5 hours, then adding a lubricant at a proportion of 0.1-0.5 wt %, and performing molding treatment.

According to an embodiment of the present disclosure, the lubricant may be selected from organic lubricants and solid lubricants. Examples of the organic lubricants include oleamide, lauric amide, zinc stearate, and the like. Examples of the solid lubricants include graphite and the like. By adding the crushing adjuvant, a finely-ground powder in which orientation is easily generated when a magnetic field is applied in the molding step can be obtained. Only one of the organic lubricant and the solid lubricant may be used, or both may be used in combination.

According to an embodiment of the present disclosure, the method further comprises subjecting the composition to a molding step. In the molding step, a mixture of the metal composition may be dry-molded. For example, a mold disposed in a magnetic field is filled with the mixture of the metal composition followed by pressurization to mold the mixture of the metal composition into a molded body. In this case, by applying a magnetic field while molding, the mixture of the metal composition may be molded with the crystallographic axes being oriented in a specific direction. In the molding step, a molding adjuvant known in the art may be added as needed. Preferably, the pressure during pressurization may be, for example, not less than 30 MPa and not more than 300 MPa; the applied magnetic field may be a static magnetic field and/or a pulsed magnetic field, and the magnetic field intensity thereof may be, for example, not less than 1.5 T and not more than 8 T.

It should be understood by those skilled in the art that the specific shape of the molded body is not particularly limited, and may be adjusted according to the application conditions of the permanent magnet material. For example, the molded body may have a rectangular parallelepiped shape, a flat plate shape, a columnar shape, a ring shape, a C-shape, or the like.

According to an embodiment of the present disclosure, the time for each aging treatment is not particularly limited, and for example, may be independently selected from not less than 2 hours and not more than 10 hours, or not less than 2 hours and not more than 8 hours. The atmosphere during sintering is not particularly limited. For example, the atmosphere may be an inert atmosphere, a vacuum atmosphere of less than 100 Pa, or a vacuum atmosphere of less than 10 Pa.

The present disclosure further provides use of the permanent magnet material described above in the fields of motors, loudspeakers, magnetic separators, computer disk drivers, magnetic resonance imaging devices, and the like, preferably use thereof as a motor rotor steel magnet in motors.

### Beneficial Effects

The permanent magnet material having the multilayer structure of the present disclosure can obtain a high-performance permanent magnet material under the condition of a reduced content of Nd. According to the present disclosure, by the means of powder preparation, mixing, pressing, and sintering, the performance defect such as the reduction of the magnet property caused by CeY entering the main phase grains is effectively avoided, and the influence of the formation of a CeFe₂ phase in the grain boundaries on the magnet property is also avoided. Moreover, by the means of the introduction of M, the inhibition of CeY enrichment in the grain boundaries on the diffusion effect is avoided, a diffusion channel of heavy rare earth from the surface of the magnet to the interior is provided, and thus the diffusion effect is optimized, and the diffusion performance is significantly improved. The manufacturing cost of the magnet is reduced, and the balance and sustainable utilization of rare earth resources are achieved.

### BRIEF DESCRIPTION OF THE DRAWINGS

The figure is a schematic diagram of the cross-section of the permanent magnet material comprising a main phase and a three-layer shell structure according to the present disclosure.

### DETAILED DESCRIPTION

The embodiments of the present disclosure will be further illustrated in detail with reference to the following specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the starting materials and reagents used in the following examples are all commercially available products, or can be prepared using known methods.

Unless otherwise stated, the percentage in the following examples is defined as mass percentage, and the proportion is mass ratio.

### Instruments and Methods

### [Empa Assay]

The instrument was an EPMA-1720 type electron probe microscope manufactured by Shimadzu corporation, Japan.

The test conditions were as follows: the accelerating voltage was 10 kV, the beam current was 20 nA, the test time for elements B and O was 30 s, the time for background test was 10 s, and the time for other elements were default to be 10 s.

### [Magnetic Property Test]

The instrument was an NIM-62000 type rare earth permanent magnet measuring system from the National Institute of Metrology.

The test condition: room temperature

### Example 1: Universal Preparation Method and Test Method for Permanent Magnet Material

### (1) Smelting

The starting materials of the target components were placed in a crucible, heated and melted into molten steel by medium-frequency induction current under vacuum (the pressure was not more than 1 Pa), and quenched by a melt-spinning process to give alloy scales.

### (2) Powder Preparation

The prepared R-T-B alloy and the CeY alloy were mixed together at the following proportion A (R-T-B alloy:CeY alloy) and then subjected to hydrogen decrepitation (HD) treatment, where the HD hydrogen absorption pressure was 200 kPa, dehydrogenation treatment was performed after saturated hydrogen absorption and decrepitation, where the dehydrogenation temperature was 350° C. and the dehydrogenation time was 3 hours, and then crushing was performed by jet milling or a combined mode of medium grinding and jet milling to give a jet-milled powder with the target particle size SMD of 2.5 μm.

The prepared jet-milled powder was added with an M compound at a proportion of B wt %, based on the mass of the jet-milled powder. Heat preservation treatment was performed on the jet-milled powder added with the M compound at 450° C. for 4 hours, then a lubricant was added at a proportion of 0.3 wt %, and molding treatment was performed. Then, the powder was mixed for 3 hours in a three-dimensional rotary mixing manner to be uniformly dispersed.

### (3) Pressing

Under the condition that the oxygen content was not more than 50 ppm, an automatic press was adopted, under the action of 2 T direct current coil saturated magnetizing field intensity, the powder was directionally pressed into a blank body with a fixed dimension, and cold isostatic pressing and pressure maintaining were performed for 10 seconds under 200 kPa, so as to further increase the density of the blank body.

### (4) Sintering

The blank body subjected to the cold isostatic pressing treatment was placed in a sintering furnace, heat preservation treatment was performed at 1060° C. for 6 hours under vacuum (the pressure was not more than 10 Pa), then the blank body was cooled to room temperature, and then heated to 880° C., heat preservation treatment was performed for 4 hours, followed by the primary aging treatment, then the blank body was cooled to room temperature, and heated to 530° C., and heat preservation was performed for 6 hours, followed by the secondary aging treatment.

### (5) Magnetic Property Test

The material subjected to the secondary aging treatment described above was processed into @10-10 cylinder, and the property of the magnet was measured by using NIM-62000 type magnetic tester.

### (6) Diffusion

The sintered magnet was processed into square pieces with the dimension of 20 mm*20 mm*3 mm, the Dy powder accounting for 0.8 wt % of the weight of the magnet was uniformly distributed on the surface of the magnet, and the magnet was heated to 900° C. under an inert gas argon atmosphere with the pressure of 30 kPa, subjected to heat preservation treatment for 15 hours, subjected to diffusion treatment, cooled to room temperature, then heated to 530° C. and subjected to heat preservation for 5 hours, and then subjected to diffusion aging treatment.

### (7) Diffused Magnetic Property Test

The diffused magnet was processed into square pieces with the dimension of 10 mm*10 mm*3 mm, and the property of the magnet was measured by using NIM-62000 type magnetic tester.

### Example 2: Preparation and Performance Test of Permanent Magnet Material Samples 1-4 and Comparative Samples 1-8

According to the universal method in Example 1, the R-T-B alloy samples, the CeY alloy samples, the M compound samples, and the permanent magnet material samples were prepared according to the following tables:

TABLE 1
Composition of R-T-B alloy sample

| | Sample | | | | | | | | |
|---|---|---|---|---|---|---|---|---|---|
| | Nd % | Ce % | Dy % | B % | Co % | Ti % | Ga % | Al % | Fe % |
| a1 | 29 | 0 | 2 | 1 | 1 | 0.15 | 0.3 | 0.2 | Balance |
| a2 | 28 | 4 | 0 | 0.9 | 0.5 | 0.15 | 0.2 | 0.1 | Balance |

TABLE 2
Composition of CeY alloy sample

| | CeY alloy composition |
|---|---|
| Sample | (wt/wt) |
| b1 | Ce:Y = 80:20 |
| b2 | Ce:Y = 60:40 |

TABLE 3
Composition of M compound sample

| Sample | M compound |
|---|---|
| c1 | CuO |
| c2 | B₂O₃ |

TABLE 4
Composition of magnet material sample

| | Main phase | | | | |
|---|---|---|---|---|---|
| Magnet material | alloy | CeY alloy | | M compound | |
| Sample No. | R-T-B alloy | Sample | Ratio A | Sample | Ratio B |
| Sample 1 | a1 | b1 | 4% | c1 | 0.30% |
| Sample 2 | a1 | b1 | 4% | c2 | 0.50% |
| Sample 3 | a2 | b1 | 2% | c1 | 0.30% |
| Sample 4 | a2 | b1 | 2% | c2 | 0.50% |
| Comparative sample 1 | a1 | b2 | 4% | c1 | 0.30% |
| Comparative sample 2 | a1 | b2 | 4% | c2 | 0.50% |
| Comparative sample 3 | a2 | b2 | 2% | c1 | 0.30% |
| Comparative sample 4 | a2 | b2 | 2% | c2 | 0.30% |
| Comparative sample 5 | a2 | — | — | c1 | 0.30% |
| Comparative sample 6 | a1 | b1 | 4% | c1 | 6.00% |
| Comparative sample 7 | a2 | b1 | 2% | — | — |
| Comparative sample 8 | a2 | b2 | 2% | — | — |

“—” indicates no addition.

Magnetic property tests and shell structure tissue analyses were performed on the magnet samples of samples 1-4 and comparative samples 1-8 by using the method in Example 1, and the detection data were analyzed as follows:

| | | | | | | Thickness of shell structure | | |
|---|---|---|---|---|---|---|---|---|
| | Before | | After | | | (nm) | | |
| Magnet | diffusion | | diffusion | | | First | Second | Third |
| sample | Br | Hcj | Br | Hcj | ΔHcJ | shell | shell | shell |
| No. | (T) | (kA/m) | (T) | (kA/m) | (kA/m) | structure | structure | structure |
| Sample 1 | 1.342 | 1563 | 1.323 | 2167 | 604 | 5 | 2 | 6 |
| Sample 2 | 1.347 | 1549 | 1.319 | 2139 | 590 | 5 | 3 | 6 |
| Sample 3 | 1.273 | 1067 | 1.251 | 1630 | 563 | 3 | 2 | 6 |
| Sample 4 | 1.268 | 1055 | 1.248 | 1626 | 571 | 3 | 3 | 6 |
| Comparative | 1.327 | 1326 | 1.301 | 1648 | 322 | 7 | 1 | 3 |
| sample 1 | | | | | | | | |
| Comparative | 1.328 | 1319 | 1.296 | 1632 | 313 | 7 | 2 | 3 |
| sample 2 | | | | | | | | |
| Comparative | 1.247 | 976 | 1.212 | 1275 | 299 | 5 | 1 | 4 |
| sample 3 | | | | | | | | |
| Comparative | 1.243 | 945 | 1.208 | 1283 | 338 | 6 | 2 | 3 |
| sample 4 | | | | | | | | |
| Comparative | 1.362 | 1593 | 1.332 | 2139 | 546 | — | 2 | 5 |
| sample 5 | | | | | | | | |
| Comparative | 1.335 | 1528 | 1.317 | 2086 | 558 | 5 | 5 | 4 |
| sample 6 | | | | | | | | |
| Comparative | 1.345 | 1520 | 1.324 | 2017 | 497 | 5 | — | 4 |
| sample 7 | | | | | | | | |
| Comparative | 1.278 | 1028 | 1.250 | 1537 | 509 | 7 | — | 3 |
| sample 8 | | | | | | | | |

The experimental results described above show that although comparative samples 1-4 had a three-layer shell structure, due to the larger thickness of the first shell structure (Ce/Y-rich layer), not only the magnet property was greatly reduced, but also the diffusion effect was relatively poor, and ideal Hcj amplification was not obtained. Moreover, since the Y proportion in the CeY alloy sample b2 was high, excessive Y inevitably segregated into the main phase at a high proportion during production, resulting in a great decrease in magnet property relative to samples 1-4.

As can be seen from the comparison of the experimental results of comparative samples 5, 7, and 8 and samples 1 and 3, the magnet did not process the three-layer shell structure proposed in the present disclosure due to the absence of the CeY alloy or the M compound, and the cost reduction effect obtained by using the high-abundance low-cost CeY starting materials could not be achieved. Moreover, since comparative samples 7 and 8 had no M compound added, the second shell structure could not be formed, and the improvement of the effect of promoting the diffusion of grain boundaries could not be achieved as well.

As can be seen from the comparison of the experimental results of the comparative sample 6 and sample 1, although the thickness of the second shell structure could be increased by increasing the proportion of the M compound added, a relatively significant agglomeration effect was generated due to an excessively high addition amount, so that the improvement of the magnet property was inhibited, and the diffusion effect was relatively poor.

### Example 3: Preparation and Performance Test of Comparative Samples 9 and 10

Referring to the universal method in Example 1 and the composition of sample 1, the difference in this example was that the heating and heat preservation temperature was adjusted to 620° C. in the heat treatment process for the powder added with the M compound, and the powder was then pressed, sintered, and diffused to give the magnet material comparative sample 9.

Referring to the universal method in Example 1 and the composition of sample 1, the difference in this example was that after the powder was added with the M compound, the heating and heat preservation treatment process was not performed, the lubricant was directly added, followed by mixing, and the mixture was then pressed, sintered, and diffused to give the magnet material comparative sample 10.

Magnetic property tests and shell structure tissue analyses were performed on the magnets of comparative samples 9 and 10, and the detection data were analyzed as follows:

| | | | | | | Thickness of shell structure | | |
|---|---|---|---|---|---|---|---|---|
| | | | | | | (nm) | | |
| Magnet | Before diffusion | | After diffusion | | | First | Second | Third |
| sample | Br | Hcj | Br | Hcj | ΔHcJ | shell | shell | shell |
| No. | (T) | (kA/m) | (T) | (kA/m) | (kA/m) | structure | structure | structure |
| Comparative | 1.351 | 1518 | 1.324 | 2087 | 569 | 5 | 4 | 3 |
| sample 9 | | | | | | | | |
| Comparative | 1.342 | 1517 | 1.326 | 2085 | 568 | 4 | 5 | 4 |
| sample 10 | | | | | | | | |

The experimental results of comparative samples 9 and 10 described above show that the heating and heat preservation temperature for the powder was relatively high, or the powder was not subjected to the heating and heat preservation treatment process, so the property of the magnet were significantly reduced, and the amplification of diffused Hcj was also significantly reduced. As can be seen from the grain structure, the thickness of the second shell structure increased abnormally, and in the shell structure, the grain boundaries had poor coating effect on the main phase grains, so that an excellent magnetic isolation effect could not be achieved, the property of the magnet was relatively low, and a good diffusion channel could not be provided, and thus the effective enrichment of a heavy rare earth element Dy on the surface of the magnet was inhibited, and the diffusion effect was reduced.

The above examples illustrate the embodiments of the present disclosure. However, the protection scope of the present disclosure is not limited to the embodiments described above. Any modification, equivalent replacement, improvement, and the like made by those skilled in the art without departing from the spirit and principle of the present disclosure shall fall within the protection scope of the present disclosure.

1. A permanent magnet material, wherein a microstructure of the permanent magnet material comprises a main phase and an at least three-layer shell structure, wherein the three-layer shell structure comprises a first-layer shell structure, a second-layer shell structure, and a third-layer shell structure disposed from near to far according to distances between the structures and the main phase, wherein,
the main phase comprises R-T-B main phase grains, wherein the R is selected from one, two, or more of neodymium (Nd), praseodymium (Pr), gadolinium (Gd), holmium (Ho), dysprosium (Dy), and terbium (Tb); the T comprises iron (Fe), and optionally other metal elements present or absent; the B is boron;
the first-layer shell structure is a Ce-rich and/or Y-rich layer, preferably the CeY-rich layer;
the second-layer shell structure is a layer comprising M, wherein the M is selected from one, two, or more of transition metal elements, low-melting-point metals, and non-metal elements;
the third-layer shell structure is a layer rich in a heavy rare earth element, wherein the heavy rare earth element is selected from one, two, or more of terbium (Tb), dysprosium (Dy), and holmium (Ho).

2. The permanent magnet material according to claim 1, wherein the R is preferably selected from Nd and NdPr;
the T is selected from iron (Fe) or a mixture of iron and other metal elements; the other metals are selected from one, two, or more of transition metal elements and low-melting-point metal elements;
preferably, the transition metal element is selected from one, two, or more of copper (Cu), zirconium (Zr), titanium (Ti), tin (Sn), and manganese (Mn);
the low-melting-point metal element is selected from one or two of Al, Ga, and the like;
the non-metal is boron;
more preferably, the M can be selected from one or more of Cu, Ga, Al, Zr, Ti, Sn, Mn, B, V, and Se, such as one or more of Cu, Ga, Al, Zr, Ti, Sn, Mn, and Se, preferably one, two, or more of Cu, Ga, Al, Sn, and Mn.

3. The permanent magnet material according to claim 1, wherein the mass percentage of the R in the main phase grains is 27% to 33%; and/or, the mass percentage of the T is 63% to 70%; and/or, the mass percentage of the B is 0.85% to 1.1%;
preferably, the ratio of (Pr+Nd)/RE in the main phase grains is not less than 90%;
the ratio of (Ce+Y)/RE in the first-layer shell structure is not less than 20%, based on the mass percentage;
the mass percentage of the M in the second-layer shell structure is not less than 5%, based on the mass percentage;
the ratio of HRE/RE in the third-layer shell structure is not less than 20%, based on the mass percentage;
more preferably, the thicknesses of the first-layer shell structure, the second-layer shell structure, and the third-layer shell structure are the same as or different from each other, and are independently selected from 1-6 nm;
for example, the thickness of the first-layer shell structure can be selected from 2-6 nm, such as 3-5 nm;
the thickness of the second-layer shell structure can be selected from 1-4 nm, such as 2-3 nm;
the thickness of the third-layer shell structure can be selected from 5-7 nm, such as 6 nm.

4. The permanent magnet material according to claim 1, wherein,
the mass percentage of the R is not less than 28.5% and not more than 32.5%, based on the mass of the permanent magnet material;
the mass percentage of the B is not less than 0.88% and not more than 1.05%, based on the mass of the permanent magnet material;
the total mass percentage of the M is not less than 0.1% and not more than 4.0%, preferably not less than 0.3% and not more than 3.0%, based on the mass of the permanent magnet material;
preferably, the permanent magnet material can comprise Co; the mass percentage of the Co is not less than 0% and not more than 3.0%, based on the mass of the permanent magnet material;
more preferably, the balance of the permanent magnet material is Fe, O, and an inevitable impurity.

5. A composition, comprising an R-T-B alloy, a CeY alloy, and an M compound;
wherein the R, the T, the B, and the M have the definitions as defined in claim 1;
preferably, in the composition, the mass ratio of the R-T-B alloy to the CeY alloy is 1:(0.01-0.1);
the mass percentage of the M compound is 0.05 wt % to 5 wt %, based on the sum of the masses of the R-T-B alloy and the CeY alloy;
the mass percentage of the Y is 10 wt % to 30 wt %, based on the mass of the CeY alloy.

6. The composition according to claim 5, wherein the M compound is selected from one, two, or more of oxides, nitrides, and fluorides of the transition metal elements Ga and Al, and oxides and nitrides of non-metals;
preferably, the composition is present in the form of a powder;
the particle size of the powder can be not more than 500 μm, for example, 0.5 μm to 300 μm, preferably 1 μm to 200 μm.

7. A method for preparing a permanent magnet material, comprising sintering the composition according to claim 5;
preferably, the sintering comprises two aging treatments;
preferably, the two aging treatments comprise a primary aging treatment at the temperature of 700-950° C. and a secondary aging treatment at the temperature of 450-560° C.;
preferably, the composition is further subjected to a powdering process before the sintering treatment;
the powdering process can be selected from a powder metallurgy process and a hydrogen decrepitation and jet milling process.

8. The method according to claim 7, comprising the following steps:
(1) performing hydrogen decrepitation treatment on a mixture of the R-T-B alloy and the CeY alloy to obtain a hydrogen-decrepitated product;
(2) performing dehydrogenation treatment on the hydrogen-decrepitated product in the step (1) to obtain a dehydrogenated product;
(3) crushing the dehydrogenated product obtained in the step (2) by jet milling or a combined mode of medium grinding and jet milling to obtain a jet-milled powder;
(4) mixing the jet-milled powder obtained in the step (3) with the M compound to obtain a mixture;
(5) performing heat treatment on the mixture obtained in the step (4) to obtain a heat-treated product; and
(6) molding the heat-treated product in the step (5).

9. The method according to claim 8, wherein,
in the step (1), the hydrogen absorption pressure of the hydrogen decrepitation treatment is 150 kPa to 250 kPa;
in the step (2), the temperature of the dehydrogenation treatment is 300-450° C., and/or, the time for the dehydrogenation treatment is 1˜4 hours;
in the step (3), the target particle size SMD of the jet-milled powder is 1.5-3.5 μm;
in the step (4), the proportion of the M compound added is 0.05-0.5 wt %, based on the mass of the jet-milled powder;
in the step (5), the temperature of the heat treatment is 300-550° C.; and/or, the time for the heat treatment is 3-5 hours.

10. Use of the permanent magnet material according to claim 1 in the fields of motors, loudspeakers, magnetic separators, computer disk drives, magnetic resonance imaging devices, and the like, preferably use thereof as a motor rotor steel magnet in motors.
